(19) United States
(12) Patent Application Publication
(10) Pub. No.: US 2004/0239606 A1
(43) Pub. Date: Dec. 2, 2004

(54) Display driver, electro optic device, electronic apparatus, and display driving method

(76) Inventor: Yusuke Ota, Nagano-ken (JP)

Correspondence Address: HARNESS, DICKEY & PIERCE, P.L.C., P.O. BOX 828, BLOOMFIELD HILLS, MI, 48303, US

(21) Appl. No.: 10/807,542

(22) Filed: Mar. 23, 2004

(30) Foreign Application Priority Data
Mar. 24, 2003 (JP) 2003-080151

(51) Int. Cl. G09G 3/36

(52) U.S. Cl. 345/98

(57) ABSTRACT

A display driver is provided including a display data RAM including a plurality of memory cells each storing display data of one pixel, a display address decoder selecting a word line of the display data RAM based on a display address, a display column address decoder selecting a column line of the display data RAM based on a display column address, read-out bit lines RB1 through RBM each coupled to a memory cell specified by a column line, a scroll display data generating circuit shifting display data output to each read-out bit line by a shift amount in line with a given scroll amount so as to generate display data, and a driving circuit driving data lines based on the display data.

### RELATED APPLICATIONS

This application claims priority to Japanese Patent Application No. 2003-080151 filed Mar. 24, 2003 which is hereby expressly incorporated by reference herein.

### BACKGROUND

1. Field of the Invention

The present invention relates to a display driver, an electro optic device, an electronic apparatus, and a display driving method.

2. Description of the Related Art

Display panels (electro optic devices in a broad sense) represented by liquid crystal display (LCD) panels are installed in cellular phones and personal display assistants. In particular, LCD panels achieve miniaturization, low power consumption, and low cost compared to other display panels, and are used for various types of electronic apparatuses.

An LCD panel includes, for example, a plurality of scan lines, a plurality of data lines, and a plurality of pixels that are coupled to the scan lines and the data lines. The data lines of the LCD panel are driven by a display driver based on display data, while the scan lines of the LCD panel are driven by a scan driver.

The display driver reduces power consumption with a built-in display data random access memory (RAM) that stores display data of one frame, for example. The display data are supplied to the display driver by a host such as an external micro processor unit (MPU). The display data RAM includes a plurality of memory cells. In the display data RAM, the arrangement of each memory cell corresponds to the arrangement of pixels of the LCD panel. Each memory cell stores display data of one pixel, for example, supplied by the host. For example, display data are read out on a display-line-by-display-line basis (hereinafter simply referred to as “line by line”) and supplied for driving the data lines of the LCD panel from a display data RAM that stores display data of one frame (see WO00/02189).

As the display data are read out line by line from the display data RAM, it is difficult to scroll a display screen of the LCD panel in the display line direction. For example, when vertical scanning runs from top to bottom of a display screen, it is possible to vertically scroll the screen, while it is difficult to horizontally scroll the screen. In order to horizontally scroll the screen by means of a display driver with a built-in display data RAM, either of the following methods has been employed: (1) making the host rewrite display data of horizontally scrolled images in the display data RAM, or (2) replacing display data stored in the display data RAM with display data of horizontally scrolled images inside the display driver (see Japanese Unexamined Patent Application Publication No. 9-265274).

When employing the first method to horizontally scroll a screen by means of the display driver with the built-in display data RAM, power consumption increases due to an interface between the display driver and the host. This makes providing the display data RAM with the display driver meaningless.

Meanwhile, using the second method for the display driver with the built-in display data RAM as described in Japanese Unexamined Patent Application Publication No. 9-265274 requires a clock for reading out display data of one frame for replacement and a clock for rewriting new display data of one frame in the display data RAM, which increases power consumption.

The invention addresses these technical issues, and aims to provide a display driver, an electro optic device, an electronic apparatus, and a display driving method that are capable of horizontal scrolling while reducing power consumption.

### SUMMARY

In order to solve the above-mentioned issues, the invention pertains to a display driver for driving data lines of an electro optic device based on display data. The display driver includes a display data RAM including a plurality of word lines, a plurality of column lines, and a plurality of memory cells each storing display data of one pixel; a display address decoder selecting a word line of the display data RAM based on a display address; a display column address decoder selecting a column line of the display data RAM based on a display column address; a plurality of read-out bit lines each commonly coupled to a memory cell group specified by a corresponding column line; a scroll bus coupled to the plurality of read-out bit lines; a plurality of data latches each corresponding to each data line of the electro optic device and loading display data on the scroll bus; and a driving circuit driving the data lines based on the display data loaded in the plurality of data latches. In the display driver, display data of one pixel are read out from a memory cell specified by a word line selected by the display address decoder and a column line selected by the display column address decoder, the data are output to the scroll bus via the read-out bit line coupled to the memory cell, and the data on the scroll bus are loaded in each of the plurality of data latches.

According to this configuration, display data read out from a memory cell composing the display data RAM are output to the scroll bus, and the display data on the scroll bus are then loaded in any of the plurality of data latches that are commonly coupled to the scroll bus. Therefore, it is possible to drive the data lines based on display data after scrolling in line with an intended scroll amount in the horizontal scan direction without replacing display data stored in the display data RAM. This does not require a clock for reading out display data of one frame for replacement and a clock for rewriting new display data of one frame in the display data RAM, and thereby reducing power consumption and performing horizontal scrolling on a display.

Moreover, it is also possible to easily perform scrolling in an oblique direction with low power consumption by combining horizontal scrolling and vertical scrolling, which is performed by changing word lines selected by the display address decoder.

The display driver according to the invention also includes a shift register outputting a shift output shifted based on a given shift clock. In the display driver, each of the plurality of data latches loads display data on the scroll bus based on a shift output of each stage of the shift register.

According to this configuration, it is possible to generate display data for scrolling in line with an intended scroll amount with a read-out timing of display data from the display data RAM and an output timing of a shift output from the shift register. This makes it possible to perform horizontal scrolling while simplifying a circuit configuration and reducing power consumption.

The display driver according to the invention also includes a line latch loading display data that are loaded in the plurality of data latches in one horizontal scan cycle. In the display driver, the driving circuit drives the data lines based on display data loaded in the line latches instead of the plurality of data latches.

According to this configuration, it is not necessary to replace display data loaded in the plurality of data latches with display data after scrolling. This makes it possible to load display data of the next display line while driving a display line.

The invention also pertains to a display driver for driving data lines of an electro optic device based on display data. The display driver includes a display data RAM including a plurality of word lines, a plurality of column lines, and a plurality of memory cells each storing display data of one pixel; a display address decoder selecting a word line of the display data RAM based on a display address; a display column address decoder selecting a column line of the display data RAM based on a display column address; a plurality of read-out bit lines each commonly coupled to a memory cell specified by a column line; a scroll display data generating circuit including a plurality of data latches that each correspond to each data line of the electro optic device, shifting display data of one pixel that are output to each read-out bit line by a shift amount in line with a given scroll amount, and loading the data in any of the plurality of data latches, so as to generate display data of one horizontal scan line; and a driving circuit driving the data lines based on the display data of one horizontal scan line generated by the scroll display data generating circuit.

The invention also pertains to an electro optic device including a plurality of scan lines, a plurality of data lines, a plurality of pixels coupled to the plurality of scan lines and the plurality of data lines, a scan driver scanning the plurality of scan lines, and any of the above-mentioned display drivers for driving the plurality of data lines.

The invention also pertains to an electro optic device including a display panel including a plurality of scan lines, a plurality of data lines, and a plurality of pixels coupled to the plurality of scan lines and the plurality of data lines; a scan driver scanning the plurality of scan lines; and any of the above-mentioned display drivers for driving the plurality of data lines.

According to this configuration, it is possible to provide an electro optic device that enables horizontal scrolling with low power consumption.

The invention also pertains to an electronic apparatus including the above-mentioned electro optic device and a display data generating part generating display data to be supplied to the electro optic device.

According to this configuration, it is possible to contribute to providing an electronic apparatus that enables horizontal scrolling with low power consumption.

The invention also pertains to a display driving method for driving data lines of an electro optic device based on display data that are read out from a display data random access memory including a plurality of word lines, a plurality of column lines, and a plurality of memory cells each storing display data of one pixel. The display driving method includes the following steps: specifying a memory cell by a word line out of the plurality of word lines and a column line out of the plurality of column lines, outputting display data of one pixel that are stored in the memory cell to a scroll bus via a read-out bit line commonly coupled to a memory cell group that is specified by the column line, loading the display data of one pixel on the scroll bus in any of a plurality of data latches each corresponding to each data line of the electro optic device, and driving the data lines of the electro optic device based on the display data loaded in the plurality of data latches.

In the display driving method, it is possible to repeat the step of loading the display data of one pixel on the scroll bus in each of the plurality of data latches for the number of pixels to be driven in one horizontal scan cycle, so as to load display data of one horizontal scan line in the plurality of data latches, and to drive the data lines of the electro optic device based on the display data loaded in the plurality of data latches.

### BRIEF DESCRIPTION OF THE DRAWINGS

FIG. 1 is a schematic block diagram of an electronic apparatus including an electro optic device according to an embodiment of the invention.

FIGS. 2(A) and (B) are equivalent circuit diagrams showing configuration examples of a display panel.

FIG. 3 is a block diagram showing an example where the MPU and the display unit shown in FIG. 1 are installed in a cellular phone.

FIG. 4 is a block diagram showing the feature configuration of a display driver.

FIG. 5 illustrates scroll directions.

FIG. 6 shows an example of the timing of horizontal scrolling.

FIG. 7 is a block diagram showing a configuration example of an X driver IC in detail.

FIG. 8 is a circuit diagram schematically showing the configuration of a display data RAM.

FIG. 9 is a circuit diagram of a RAM cell of one bit composing each memory cell.

FIG. 10 is a circuit diagram of the scroll display data generating circuit shown in FIG. 8.

FIG. 11 is a circuit diagram of the selector shown in FIG. 10.

FIG. 12 is a circuit diagram of the shift register shown in FIG. 10.

FIG. 13 is a circuit diagram of the latch shown in FIG. 12.

FIG. 14 is a circuit diagram of the data latch shown in FIG. 10.

FIG. 15 shows an example of operational timing in a normal mode.

FIG. 16 shows an example of operational timing in a horizontal scrolling mode.

### DETAILED DESCRIPTION

Referring to the accompanying drawings, a preferred embodiment of the invention will now be described in detail. It should be noted that the invention described in the claims is not limited to the following embodiment. Also, it is not always necessary to have all elements described below to implement the invention.

1. Electro optic device

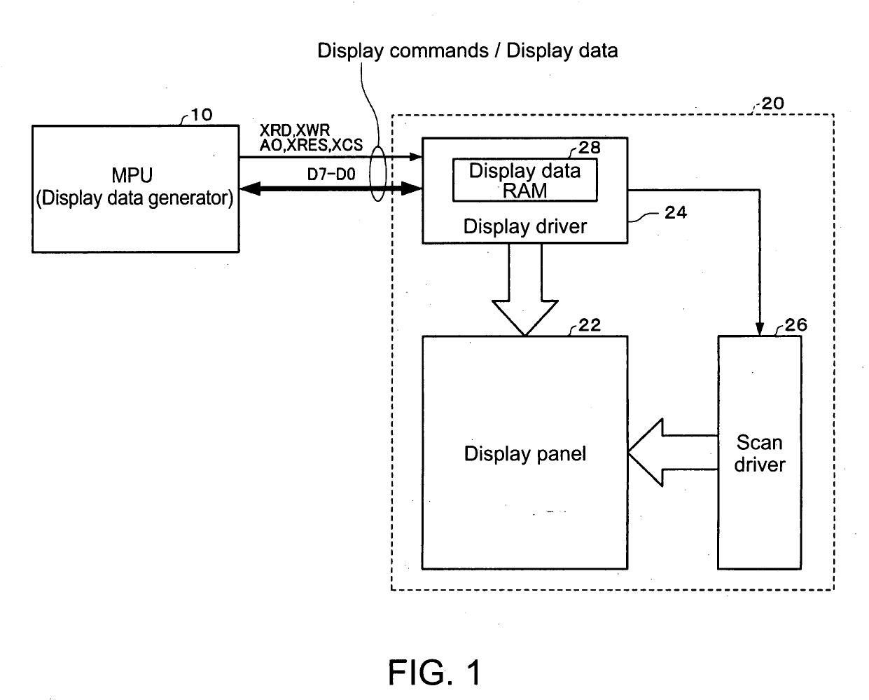

FIG. 1 is a schematic block diagram of an electronic apparatus including an electro optic device according to an embodiment of the invention. The electronic apparatus includes an MPU 10 and a display unit (an electro optic device in a broad sense) 20. The display unit 20 includes a display panel 22 that is a matrix panel having an electro optic element, a display driver (e.g. an X driver IC) 24 with a built-in RAM for driving the display panel 22, and a scan driver (e.g. a Y driver IC for scanning) 26.

The display panel 22 includes any electro optic element such as a liquid crystal whose optical characteristics are changed by applying a voltage. For example, the display panel 22 is composed of an active matrix panel.

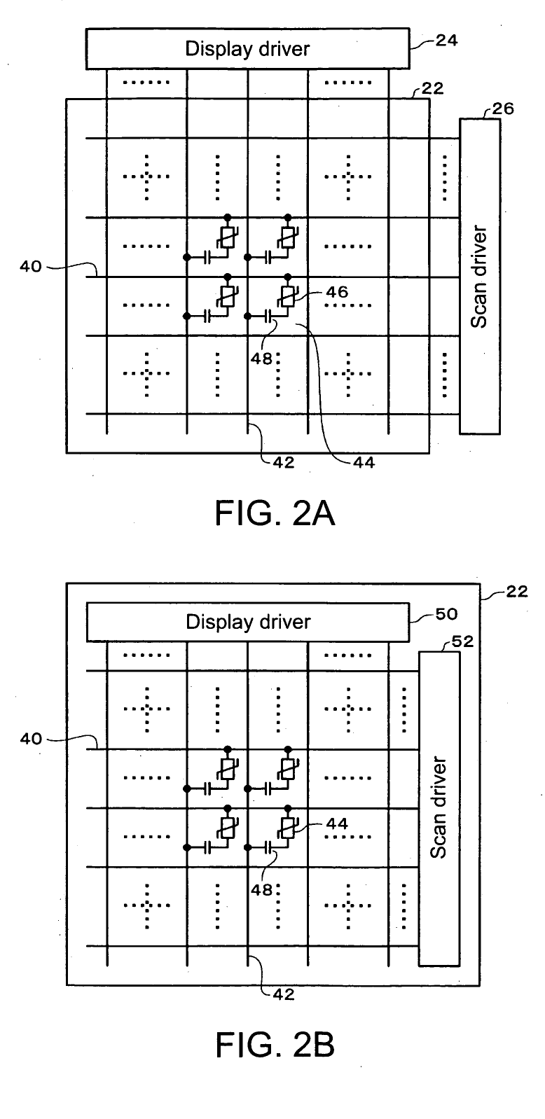

FIGS. 2(A) and (B) are equivalent circuit diagrams showing configuration examples of the display panel 22. As shown in FIG. 2(A), an active-matrix display panel using a thin film diode (TFD, a two-terminal nonlinear element in a broad sense) may be used as the display panel 22.

The display panel 22 includes a plurality of scan lines 40 and a plurality of data lines 42. The plurality of scan lines 40 are driven by the scan driver 26. The plurality of data lines 42 are driven by the display driver 24. In each pixel region 44 between the scan lines 40 and the data lines 42, a TFD 46 is coupled in series with an electro optic element (liquid crystal) 48.

The display panel 22 controls display operations by switching the display state, non-display state, and intermediate state of the electro optic element 48, based on a signal given to the scan lines 40 and the data lines 42. While the TFD 46 is coupled to the scan lines 40 side and the electro optic element 48 is coupled to the data lines 42 side in FIG. 2(A), it is also possible to couple the TFD 46 to the data lines 42 side and the electro optic element 48 to the scan lines 40 side.

As shown in FIG. 2(B), it is also possible to provide such a display panel by forming at least either a display driver 50 or a scan driver 52 on a glass substrate on which pixels are deposited. The display driver 50 has the same functions as the display driver 24 has. The scan driver 52 has the same functions as the scan driver 26 has. For example, the display panel 22 here includes the plurality of scan lines 40, the plurality of data lines 42, a plurality of pixels that are coupled to the plurality of scan lines 40 and the plurality of data lines 42, the scan driver 52 that drives the plurality of scan lines 40, and the display driver 50 that drives the plurality of data lines 42. In this case, an electro optic device is used as the display panel 22. This makes it possible to significantly reduce an area on which the panel is mounted, and contribute to provide smaller and lighter electronic apparatuses.

While a TFD is used for employing active matrix technology in the examples shown in FIGS. 2(A) and (B), applications of the invention are not limited to this. Active matrix panels using three-terminal elements such as a thin film transistor (TFT) and other two-terminal elements may be used instead.

In FIG. 1, the display driver 24 includes a display data RAM 28 that stores display data of one frame, for example.

The MPU 10 (a display data generator in a broad sense) supplies control signals, display commands, and display data to the display unit 20. The MPU 10 has functions as a display data generator. Typical examples of the control signals include a command/data indicator A0, an inversion reset signal XRES, an inversion chip select signal XCS, an inversion READ signal XRD, and an inversion WRITE signal XWR. Data D0 through D7 are eight-bit command data or display data, and are identified at the logical level of the command/data indicator A0.

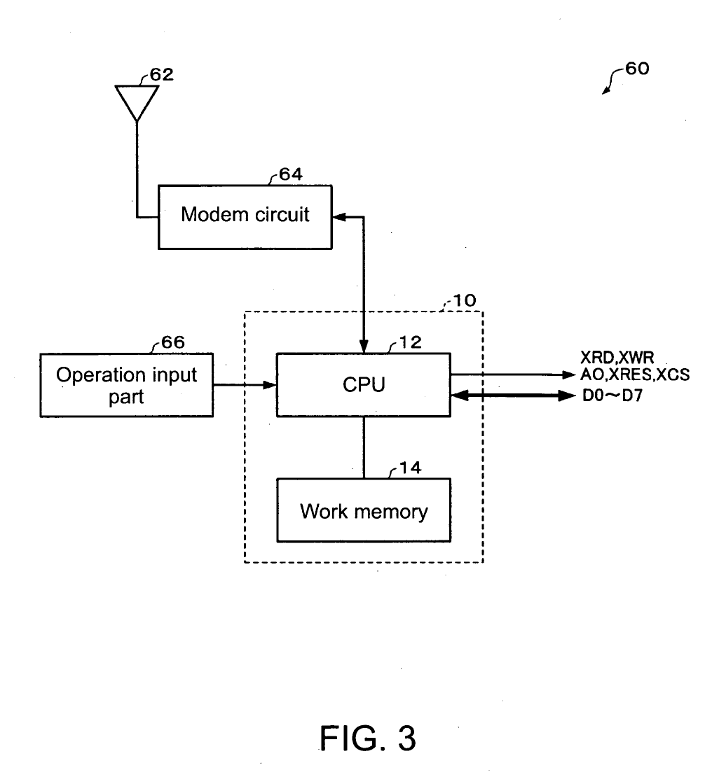

FIG. 3 shows an example where the MPU 10 and the display unit 20 shown in FIG. 1 are installed in a cellular phone. The MPU 10 here includes a central processing unit (CPU) 12 that controls a cellular phone (an electronic apparatus in a broad sense) 60. The CPU 12 is coupled to a work memory 14. The cellular phone 60 is provided with a modem circuit 64 that demodulates signals received via an antenna 62 and modulates signals to be transmitted via the antenna 62. Operational information required for transmitting and receiving data by the cellular phone 60 and for operating the display panel 22 (e.g. scrolling) is input via an operation input part 66.

Signals input via the antenna 62 are demodulated by the modem circuit 64 and processed by the CPU 12. The CPU 12 outputs various display commands or display data for operating the display panel 22 to the display unit 20, by using the work memory 14 as required according to information given by the operation input part 66. Examples of the display commands include those setting various modes for controlling operations of the display driver 24 that drives the display panel 22, and those setting a window display region on a display area of the display panel 22, for example, as a rectangle region specified by a start address “SA” and an end address “EA”.

By using the display driver 24, whose configuration will now be described, for the electronic apparatus of this embodiment represented by the cellular phone 60, it is possible to perform not only vertical scrolling but horizontal scrolling, and to reduce power consumption.

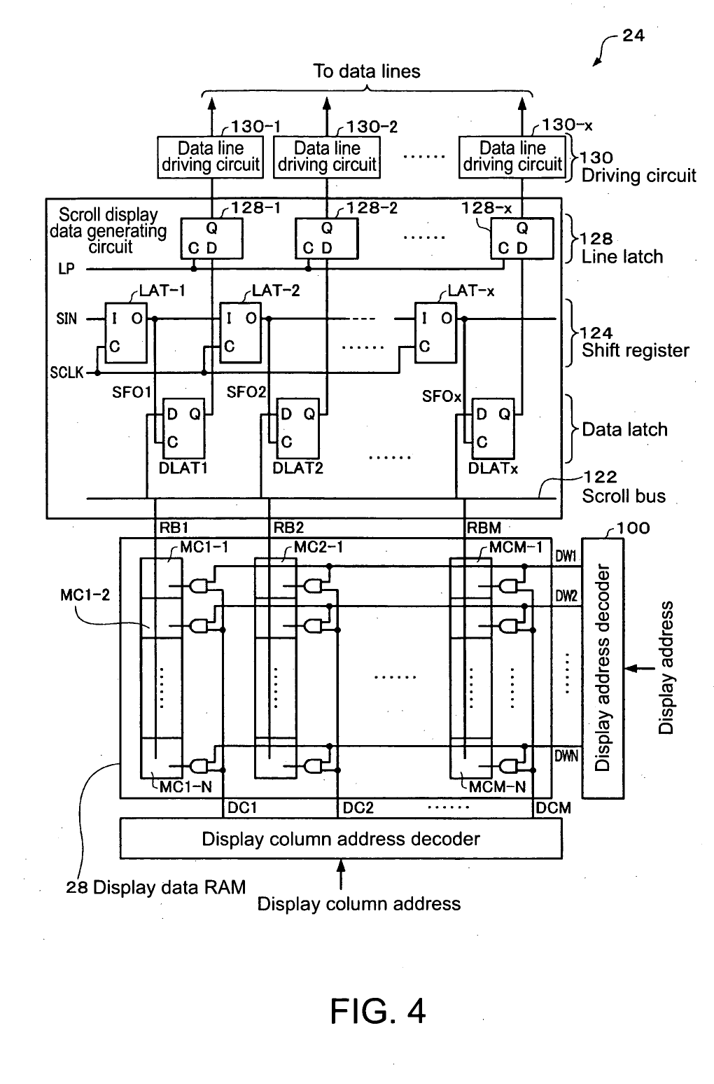

FIG. 4 is a block diagram showing the feature configuration of the display driver 24. FIG. 4 shows the configuration related to reading out of display data from the display data RAM. Here, signal lines transmitting the display data are shown in a simplified manner, assuming that each memory cell composing the display data RAM stores display data of one pixel.

The display driver 24 includes the display data RAM 28, a display address decoder 100, a display column address decoder 110, a scroll display data generating circuit 120, and a driving circuit 130.

The display data RAM 28 includes a plurality of word lines DW1 through DWN (“N” is an integer larger than 1), a plurality of column lines DC1 through DCM (“M” is an integer larger than 1), a plurality of memory cells MC1-1 through MCM-N each of which stores display data of one pixel. When a pixel is composed of six dots each for R, G, and B, each memory cell stores display data of 18 bits. The arrangement of each memory cell corresponds to the arrangement of each pixel of the display panel. Each memory cell is specified by a word line and column line. A memory cell group arranged in the word line direction (memory cells MC1-i through MCM-i in FIG. 4) is specified by a common word line DWi (1<i<N, “i” is an integer). A memory cell group arranged in the column line direction (memory cells MCj-1 through MCj-N in FIG. 4) is specified by a common column line DCj (1<j<M, “j” is an integer).

A memory cell group arranged in the column line direction is commonly coupled to a read-out bit line. For example, the memory cell group specified by the column line DCj (the memory cells MCj-1 through MCj-N) is commonly coupled to a read-out bit line RBj. Display data of one pixel that are read out from a memory cell specified by a word line and column line are output to the read-out bit line RBj.

The scroll display data generating circuit 120 includes a plurality of data latches DLAT1 through DLATX (“x” is an integer larger than 1) corresponding to each data line of the display panel 22. Each of the data latches DLAT1 through DLATx is composed of a D flip-flop (DFF). In this case, the DFF retains an input signal to a data input (D) terminal based on an input signal to a clock (C) terminal, and outputs the signal from a data output (Q) terminal.

The scroll display data generating circuit 120 generates display data of one horizontal scan line by shifting each of the display data of one pixel that are output to each read-out bit line according to a shift amount determined based on a given scroll amount and making the data be loaded in any of the plurality of data latches.

The driving circuit 130 drives data lines of the display panel 22 based on the display data of one horizontal scan line generated by the scroll display data generating circuit 120. More specifically, the driving circuit 130 includes a plurality of data line driving circuits 130-1 through 130-x corresponding to each data line of the display panel 22. A data line driving circuit 130-k (1<k<x, “k” is an integer) outputs a driving voltage corresponding to the display data of one pixel loaded in a data latch DLATk to the data lines.

The scroll display data generating circuit 120 may include a scroll bus 122 that is coupled to a plurality of read-out bit lines RB1 through RBM. In this case, the D terminal of each of the data latches DLAT1 through DLATx is commonly coupled to the scroll bus 122. Consequently, by a clock that is input to the C terminal of each of the data latches DLAT1 through DLATX, display data of one horizontal scan line are retained by the data latches DLAT1 through DLATX.

When the scroll display data generating circuit 120 includes the scroll bus 122 coupled to the data latches DLAT1 through DLATX as mentioned above, the scroll display data generating circuit 120 may include a shift register 124. In this case, a shift output of each shift register stage is used as a clock to be input to the C terminal of the data latches DLAT1 through DLATX. The shift register 124 includes a plurality of latches. LAT-1 through LAT-x corresponding to, each of the data latches. An output (O) terminal of each latch is coupled to an input (I) terminal of the latch of the following stage. The latch loads an input signal to the I terminal based on an input signal to the clock (C) terminal, and outputs the signal from the 0 terminal. A given shift clock SCLK is commonly supplied to the C terminal of each of the plurality of latches LAT-1 through LAT-x.

A shift output is obtained by shifting a shift input signal SIN to the I terminal of the fist-stage latch LAT-1 in synchronization with a shift clock. The shift output is sequentially input to the I terminal of the following-stage latches. At the same time, shift outputs SFO1 through SFOx are sequentially output from the O terminals of the latches LAT-1 through LAT-x. This makes it possible to supply pulses that are sequentially shifted and rising or falling edges that are sequentially shifted to the data latches DLAT1 through DLATX. For example, by supplying the shift clock SCLK corresponding to the read-out timing of display data from the display data RAM 28, the shift register 124 sequentially outputs the shift outputs SFO1 through SFOX for loading the display data that are read out pixel by pixel from the display data RAM 28.

Furthermore, the scroll display data generating circuit 120 may include a line latch 128. In this case, the line latch 128 includes a plurality of DFFs 128-1 through 128-x corresponding to each data line driving circuit. The Q terminal of the data latch DLATk is coupled to the D terminal of a DFF 128-k. A latch pulse LP is input to the C terminal of the DFF 128-k. The latch pulse LP is a signal for specifying a cycle of one horizontal scan line. The display data that is loaded in the DFF 128-k are supplied to the data line driving circuit 130-k. Thus, the line latch 128 loads the display data loaded in the data latches DLAT1 through DLATx in a circle of one horizontal scan line in synchronization with the latch pulse LP. The line latch 128 enables the data latches DLAT1 through DLATx to load the display data of the next display line while driving a display line.

The display driver 24 shown in FIG. 4 generates display data that are scrolled in the lateral direction (to the right or left) pixel by pixel using display data of one frame stored in the display data RAM 28, and drives data lines based on the generated display data. Here, “lateral direction” means the horizontal scan direction. At the same time, “longitudinal direction” means the vertical scan direction.

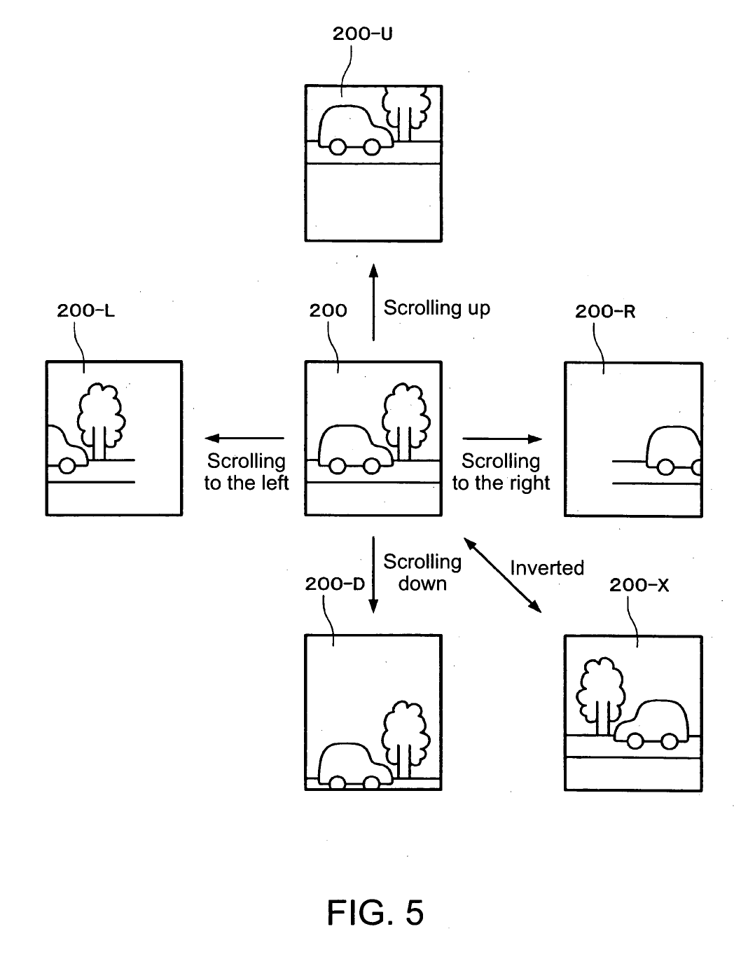

FIG. 5 illustrates scroll directions. Here, an example of horizontal and vertical scrolling of the display panel 22 seen from the front with a reference image 200 on the display panel 22 is given.

An image on the display panel 22 is scrolled to the left of the reference image 200 becomes an image 200-L that is obtained by shifting the image 200 to the left direction as shown in FIG. 5. An image on the display panel 22 is scrolled to the right of the reference image 200 becomes an image 200-R that is obtained by shifting the image 200 to the right direction as shown in FIG. 5.

An image on the display panel 22 is scrolled up from the reference image 200 becomes an image 200-U that is obtained by shifting the image 200 to the upper direction as shown in FIG. 5. An image on the display panel 22 is scrolled down from the reference image 200 becomes an image 200-D that is obtained by shifting the image 200 to the lower direction as shown in FIG. 5.

It is also possible to vertically and horizontally scroll an inverted image 200-X of the reference image 200. The image 200-X is obtained by inverting the shift direction of the shift register 124 shown in FIG. 4, changing the sequence of display data of one horizontal scan line of the display data RAM 28 with the shift direction unchanged, or inverting the increment direction of a display column address. In this case, it is also possible to invert and display a horizontally scrolled image.

In FIG. 5, the images 200-L, 200-R, 200-U, and 200-D that are scrolled only show a portion displayed in the image 200. It is also possible to display a portion other than the portion displayed in the image 200 in the images 200-L, 200-R, 200-U, and 200-D that are scrolled, by for example storing display data of a larger area than the display area of the display panel 22 in the display data RAM 28.

The display driver 24 enables the above-mentioned vertical and horizontal scrolling without changing the scan timing of the scan driver shown in FIG. 1.

Vertical scrolling is performed by changing the head display line of one frame in line with the amount of vertical scrolling. More specifically, a display address that is input to the display address decoder 100 as the head display line of one frame is specified in line with the amount of vertical scrolling. The amount of vertical scrolling is specified by operational information from the operation input part 66 shown in FIG. 3, for example.

Horizontal scrolling is performed by loading display data of one pixel in a column “m” (1<m<x, “m” is an integer) that are read out from the display data RAM 28 in a data latch DLATm1 of a column “m1” (1<m1<x, “m1” is an integer other than “m”) determined based on the amount of horizontal scrolling. This is done for a display line corresponding to a word line selected by the display address decoder 100. In FIG. 4, horizontal scrolling is performed by staggering the input timing of the display column address decoder 110 and the input timing of an shift input signal of the shift register 124 in line with the amount of horizontal scrolling. The amount of horizontal scrolling is specified by operational information from the operation input part 66 shown in FIG. 3, for example.

It is also possible to scroll an image in an oblique direction to upper right, upper left, lower right, and lower left by combining vertical scrolling and horizontal scrolling.

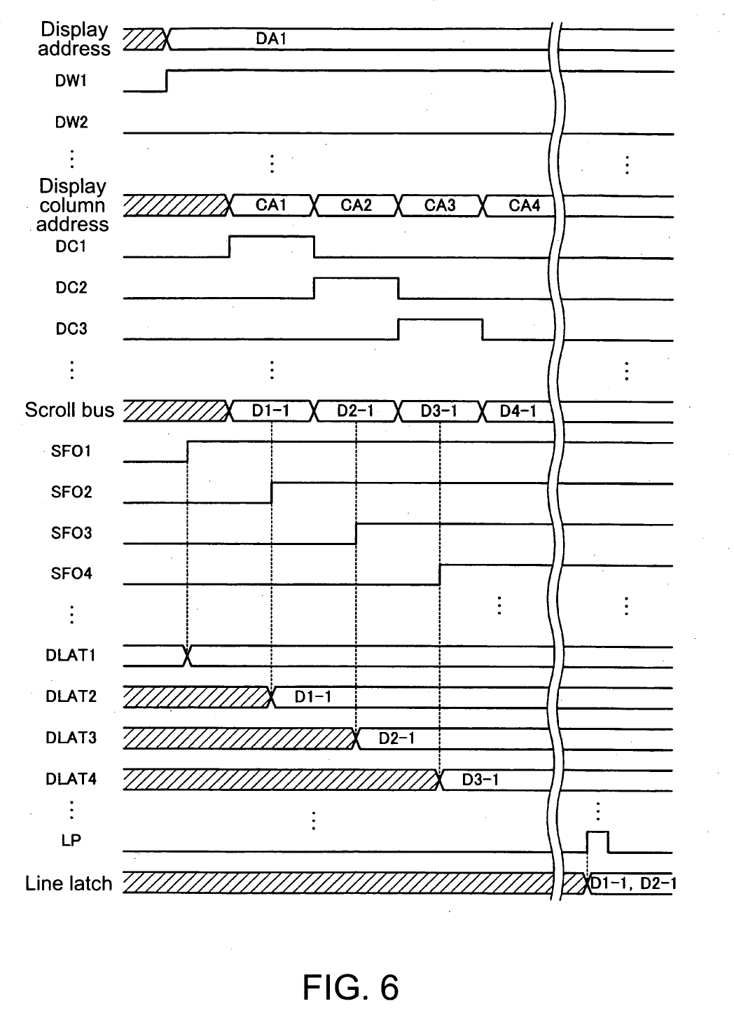

FIG. 6 shows an example of the timing of horizontal scrolling of the display driver shown in FIG. 4. The word line DW1 being selected, this diagram shows a timing example when an image is scrolled to the right by one column. With the shift outputs SFO1 through SFOx output by the shift register 124, rising edges are sequentially shifted.

For example, when a display address DA1 from a host is input, the display address decoder 100 selects the word line DW1 that corresponds to the display address DA1. In FIG. 6, the word line DW1 becomes “H” level.

Subsequently, as column addresses CA1, CA2, and so on are sequentially input, the display column address decoder 110 selects column lines DC1, DC2, and so on that correspond to the column addresses CA1, CA2, and so on. In FIG. 6, a selected column line becomes “H” level.

Thus, in the display data RAM 28, the memory cell MC1-1 is specified by the word line DW1 and the column line DC1. Consequently, in the display data RAM 28, memory cells MC2-1, MC3-1, and so on are sequentially specified by the word lines DW1 and the column lines DC2, DC3, and so on, respectively.

The read-out bit line RBj is commonly coupled to the plurality of memory cells MCj-1 through MCj-N that is specified by the column line DCj. Therefore, when the memory cell MC1-1 is specified, display data D1-1 of one pixel retained by the memory cell MC1-1 are output to the read-out bit line RB1. When the memory cell MC2-1 is specified, display data D2-1 of one pixel retained by the memory cell MC2-1 are output to a read-out bit line RB2. In the same manner, when the memory cell MC3-1 is specified, display data D3-1 of one pixel retained by the memory cell MC3-1 are output to the read-out bit line RB3. The display data output to the read-out bit lines RB1 through RBM are output to the scroll bus 122.

The shift input signal SIN is input in accordance with the input timing of the display address DA1 and the display column addresses CA1, CA2, and so on, at a timing in line with the amount of horizontal scrolling. The shift register 124 outputs the shift outputs SFO1 through SFOx, for example, as shown in FIG. 6 in synchronization with the shift clock SCLK.

The data latches DLAT1 through DLATx load the display data on the scroll bus 122 with rising edges of the shift outputs SFO1 through SFOx. Therefore, the data latch DLAT2 loads the display data D1-1 on the scroll bus 122, the data latch DLAT3 loads the display data D2-1 on the scroll bus 122, and the data latch DLAT4 loads the display data D3-1 on the scroll bus 122. Here, it is possible to output given data for non-display and display data of other column lines on the scroll bus 122 at the timing of the rising edge of the shift output SFO1 in FIG. 6.

Thus, the display data of one horizontal scan line loaded in the data latches DLAT1 through DLATX are retained by the line latch 128 based on the latch pulse LP. The display data loaded in each of a plurality of DFFs 128-1 through 128-x composing the line latch 128 are output to each data line driving circuit corresponding to each DFF.

While an example where word lines and column lines are activated in accordance with positive logic is shown in FIG. 6, they may be activated in accordance with negative logic.

As described above, a memory cell is specified by one of word lines and one of column lines in the display driver 24. Display data of one pixel stored in the specified memory cell are output to the scroll bus through the read-out bit line that is commonly coupled to the specified memory cell. The display data output on the scroll bus are loaded in one of the plurality of data latches. This process is done for each pixel. After loading display data of one horizontal scan line in each data latch, data lines of the display panel are driven according to the display data of one horizontal scan line.

The configuration of an X driver IC 400 to which the display driver 24 of this embodiment is applied will now be described in detail.

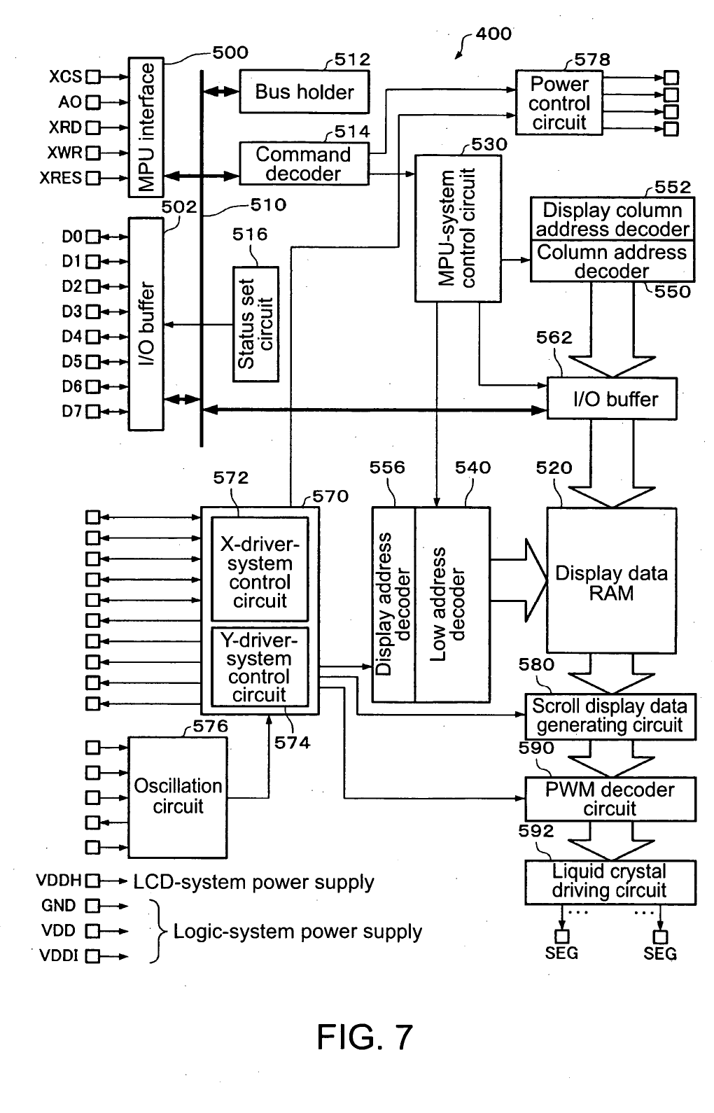

FIG. 7 shows a configuration example of the X driver IC 400 in detail. As input and output circuits of the X driver IC 400, an MPU interface 500 and an input/output (I/O) buffer 502 are provided. To the MPU interface 500, the inversion chip select signal XCS, the command/data indicator A0, the inversion READ signal XRD, the inversion WRITE signal XWR, the inversion reset signal XRES, and so on are input. To the I/O buffer 502, for example, eight-bit commands or the display data D0 through D7 are input. The X driver IC 400 is also provided with a bus line 510 that is coupled to the MPU interface 500 and the I/O buffer 502.

A bus holder 512 and a command decoder 514 are coupled to the bus line 510. In addition, a status set circuit 516 is coupled to the I/O buffer 502 so as to output the operation status of the X driver IC 400 to the MPU 10. The bus line 510 is coupled to an I/O buffer 562 of a display data RAM 520, and consequently display data for reading out and writing are transmitted to the display data RAM 520. The display data RAM 520 corresponds to the display data RAM 28 shown in FIG. 4.

As well as the display data RAM 520 and the I/O buffer 562, the X driver IC 400 is provided with an MPU-system control circuit 530, a low address decoder 540, a column address decoder 550, a driver-system control circuit 570, a scroll display data generating circuit 580, a PWM decoder circuit 590, a liquid crystal driving circuit 592, and so on. The scroll display data generating circuit 580 corresponds to the display data generating circuit 120 shown in FIG. 4.

The MPU-system control circuit 530 controls reading-out and writing operations to the display data RAM 520 based on a display command of the MPU 10 input via the command decoder 514. The MPU-system control circuit 530 also controls the low address decoder 540 and the column address decoder 550. Display data supplied by the MPU 10 are written in a memory cell specified by the low address decoder 540 and the column address decoder 550. Also, display data are read out to the MPU 10 from a memory cell specified by the low address decoder 540 and the column address decoder 550.

The X driver IC 400 also includes a display address decoder 556 that is controlled by the driver-system control circuit 570 and decodes a display address so as to specify a read-out line on a line-by-line basis. The display address decoder 556 has the same functions as the display address decoder 100 in FIG. 4 has. The X driver IC 400 also includes a display column address decoder 552 that is controlled by the MPU-system control circuit 530 or the driver-system control circuit 570 and decodes a display column address so as to specify a column of display lines. The display column address decoder 552 corresponds to the display column address decoder 110 shown in FIG. 4.

The driver-system control circuit 570 includes an X-driver-system control circuit 572 and a Y-driver-system control circuit 574. The driver-system control circuit 570 generates a gradation control pulse GCP, a polar inversion signal FR, the latch pulse LP, and so on based on an oscillation output from an oscillation circuit 576. The driver-system control circuit 570 also controls the display address decoder 556, the scroll display data generating circuit 580, the PWM decoder circuit 590, a power control circuit 578, and a Y driver IC 26.

The scroll display data generating circuit 580 reads out display data pixel by pixel stored in a memory cell of the display data RAM 520 specified by the display address decoder 556 and the display column address decoder 552, so as to generate scroll display data shifted in line with the amount of horizontal scrolling.

The PWM decoder circuit 590 latches the scroll display data, and outputs a signal whose pulse width is set based on a given gradation value in accordance with a polar inversion cycle.

The liquid crystal driving circuit 592 shifts a signal from the PWM decoder circuit 590 to have a voltage in line with a voltage of an LCD display system, and supplies the signal to data lines of the display panel 22. The liquid crystal driving circuit 592 corresponds to the driving circuit 130 shown in FIG. 4.

In the X driver IC 400, it is possible to switch a normal mode and a horizontal scrolling mode with a mode switch signal. In the normal mode, a function for generating display data after horizontal scrolling as mentioned above is “off”. In the horizontal scrolling mode, the function for generating display data after horizontal scrolling as mentioned above is “on”.

The display data RAM 520 and peripheral circuitry to read out display data will now be described.

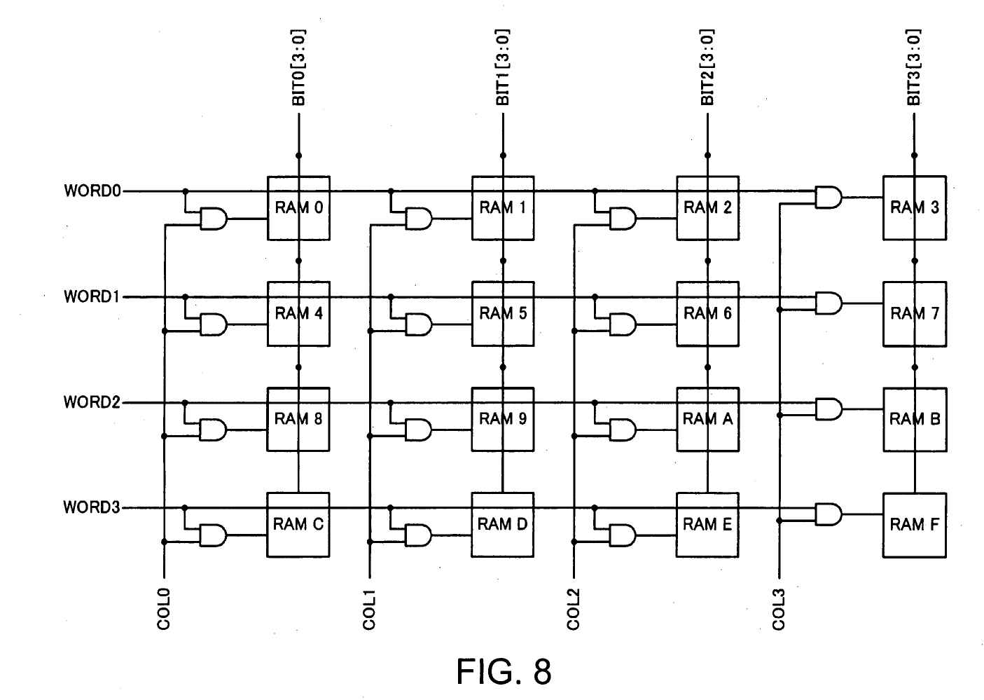

FIG. 8 shows the configuration of the display data RAM 520. For simplifying the description, it is assumed that a pixel is composed of four bits and the display data RAM 520 has a capacity for storing display data of 16 pixels. This means that the display data RAM 520 has a plurality of memory cells RAM0 through RAMF each of which stores display data of one pixel.

The display data RAM 520 also includes word lines WORD0 through WORD3 and column lines COL0 through COL3. The word lines WORD0 through WORD3 are each selected by the display address decoder 556. The column lines COL0 through COL3 are each selected by the display column address decoder 552.

Memory cells RAM0 through RAM3 are specified by the word line WORD0. Memory cells RAM4 through RAM7 are specified by the word line WORD1. Memory cells RAM8 through RAMB are specified by the word line WORD2. Memory cells RAMC through RAMF are specified by the word line WORD3. The memory cells RAM0, RAM4, RAM8, and RAMC are specified by the column line COL0. The memory cells RAM1, RAM5, RAM9, and RAMD are specified by the column line COL1. The memory cells RAM2, RAM6, RAMA, and RAME are specified by the column line COL2. The memory cells RAM3, RAM7, RAMB, and RAMF are specified by the column line COL3.

Coupled to the memory cells RAM0, RAM4, RAM8, and RAMC is a read-out bit line BIT0. Coupled to the memory cells RAM1, RAM5, RAM9, and RAMD is a read-out bit line BIT1. Coupled to the memory cells RAM2, RAM6, RAMA, and RAME is a read-out bit line BIT2. Coupled to the memory cells RAM3, RAM7, RAMB, and RAMF is a read-out bit line BIT3.

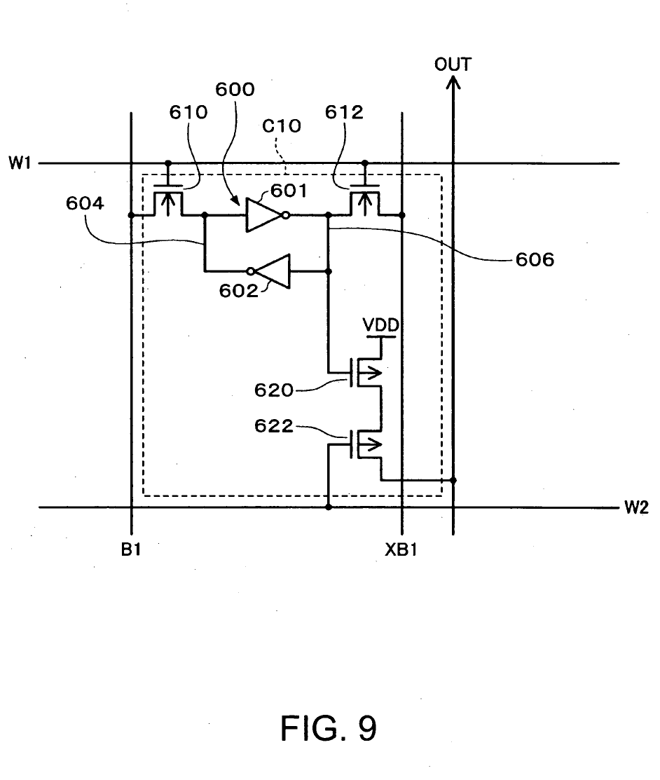

FIG. 9 is a circuit diagram of a RAM cell of one bit composing each memory cell. A RAM cell C10 has the same configuration as other RAM cells have. The RAM cell C10 includes a memory element 600 composed of two CMOS inverters 601 and 602. The two CMOS inverters 601 and 602 have a first wiring 604 and a second wiring 606 coupling the inputs and outputs of the two each other. Coupled between the first wiring 604 and a bit line B1 is a first NMOS transistor 610. The gate of the first NMOS transistor 610 is coupled to a first word line W1. Coupled between the second wiring 606 and a bit line XB1 is a second NMOS transistor 612. The gate of the second NMOS transistor 612 is coupled to the first word line W1.

In such a RAM cell, when an active signal from the low address decoder 540 turns the first word line W1 to “H” level (i.e. a logic level corresponding to a voltage of the first word line W1 becomes “H”), the first and second NMOS transistors 610 and 612 are switched to “on”. Thus, the RAM cell C10 is coupled to a pair of the bit lines B1 and XB1. Here, the RAM cell C10 is both readable and writable if the column address decoder 550 selects the RAM cell C10.

Between a power supply line VDD and a display data output line OUT, first and second PMOS transistors 620 and 622 are coupled. The gate of the first PMOS transistor 620 is coupled to the second wiring 606. The gate of the second PMOS transistor 622 is coupled to a second word line W2.

Before reading out the data of the RAM cell C10 to the display data output line OUT as a read-out bit line, the display data output line OUT is pre-charged to “L” level (i.e. a logic level corresponding to a voltage of the display data output line OUT becomes “L”). After the pre-charging, a word line selected by the display address decoder 556 and a column line selected by the display column address decoder 552 make the second word line W2 become “L” level. Consequently, the second PMOS transistor 622 is switched to “on” and the data of the display data output line OUT is latched in the PWM decoder circuit 590. Here, if the logic level of the second wiring 606 is “H“ (the logic level of the first wiring 604 is “L”), the display data output line OUT remains at “L” level. Conversely, if the logic level of the second wiring 606 is “L” (the logic level of the first wiring 604 is “H”), the display data output line OUT becomes “H” level.

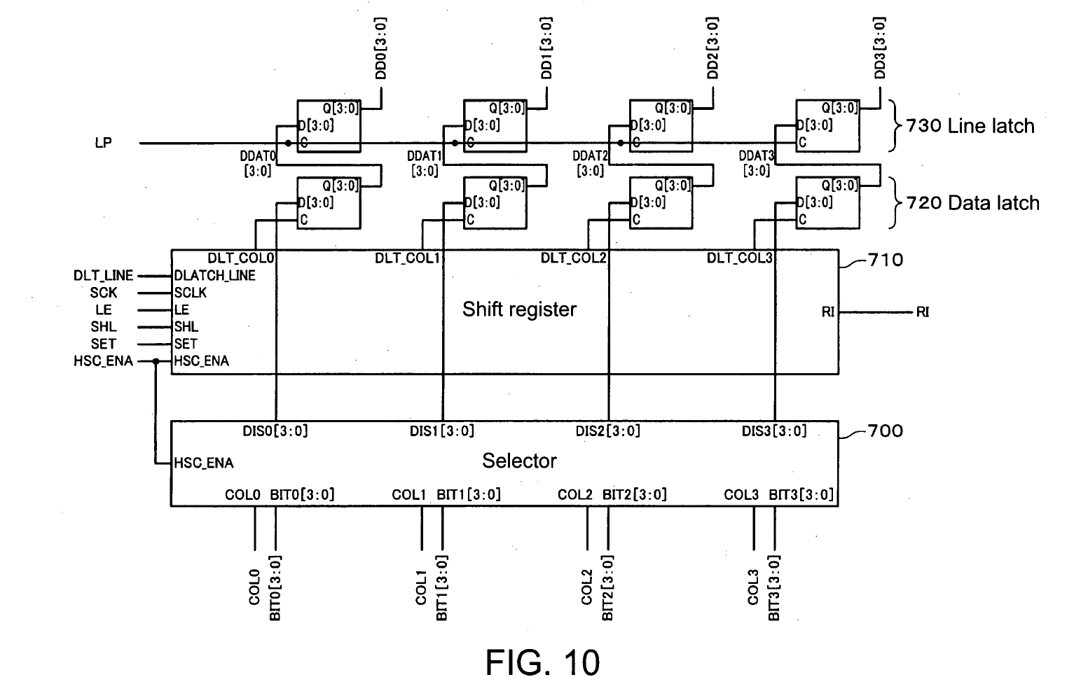

FIG. 10 is a circuit diagram of the scroll display data generating circuit 580. The scroll display data generating circuit 580 includes a selector 700, a shift register 710, a data latch 720, and a line latch 730.

The selector 700 outputs normal-mode display data or horizontal-scrolling-mode display data to the data latch 720 in response to a mode switch signal HSC_ENA.

The shift register 710 outputs a latch clock for loading normal-mode display data in the data latch 720 or a shift output for loading horizontal-scrolling-mode display data in the data latch 720 to the data latch 720 in response to the mode switch signal HSC_ENA. The shift register 710 has the same functions as the shift register 124 in FIG. 4.

The line latch 730 loads display data of one horizontal scan line loaded in the data latch 720. The line latch 730 has the same functions as the line latch 128 in FIG. 4.

In FIG. 10, a latch clock DLT_LINE, the shift clock SCLK, shift signals LE and RI, a shift direction switch signal SHL, and a set signal SET are input to the shift register 710.

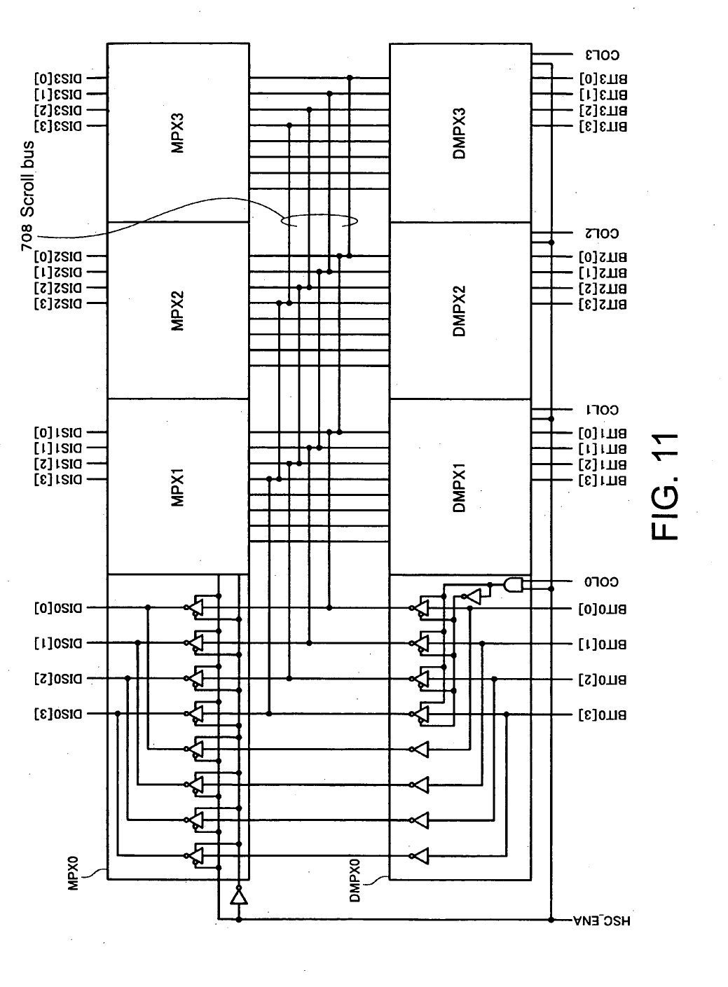

FIG. 11 is a circuit diagram of the selector 700. The selector 700 includes demultiplexers DMPX0 through DMPX 3, a scroll bus 708, and multiplexers MPX0 through MPX3. Each of the demultiplexers DMPX0 through DMPX 3 has the same configuration. Each of the multiplexers MPX0 through MPX 3 has the same configuration.

Regarding a column 0 specified by the column line COL0, the demultiplexer DMPX0 outputs a signal of the read-out bit line BIT0 to the multiplexer MPX0 or the scroll bus 708 in response to the mode switch signal HSC_ENA. More specifically, in the normal mode that is set by the mode switch signal HSC_ENA, the demultiplexer DMPX0 outputs the signal of the read-out bit line BIT0 to the multiplexer MPX0. Meanwhile, in the horizontal scrolling mode that is set by the mode switch signal HSC_ENA, the demultiplexer DMPX0 outputs the signal of the read-out bit line BIT0 to the scroll bus 708.

The scroll bus 708 corresponds to the scroll bus 122 in FIG. 4, and is commonly coupled to the demultiplexers DMPX0 through DMPX3. The scroll bus 708 is also commonly coupled to the multiplexers MPX0 through MPX3.

The multiplexer MPX0 selectively outputs a signal from the demultiplexer DMPX0 or a signal on the scroll bus 708 in response to the mode switch signal HSC_ENA. More specifically, in the normal mode that is set by the mode switch signal HSC_ENA, the multiplexer MPX0 selectively outputs the signal from the demultiplexer DMPX0. Meanwhile, in the horizontal scrolling mode that is set by the mode switch signal HSC_ENA, the multiplexer MPX0 selectively outputs the signal on the scroll bus 708.

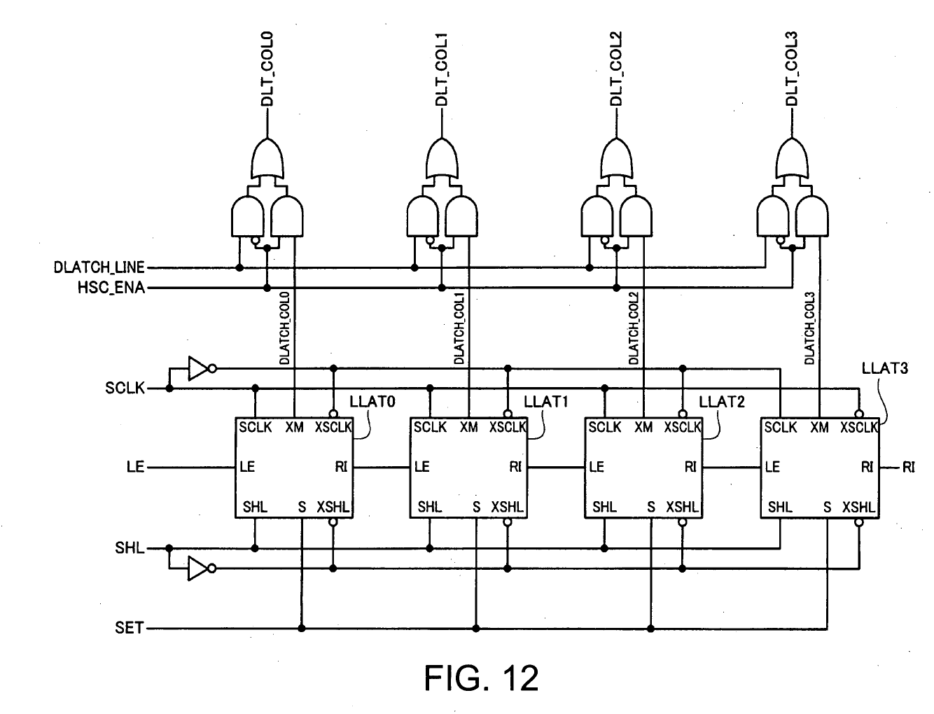

FIG. 12 is a circuit diagram of the shift register 710. The shift register 710 includes a plurality of latches LLAT0 through LLAT3 whose shift direction is shifted depending on the shift direction specified by the shift direction switch signal SHL. The shift register 710 shifts the shift signal LE or the shift signal RI based on the shift clock SCLK. In FIG. 12, rising edges set by the set signal SET are sequentially shifted.

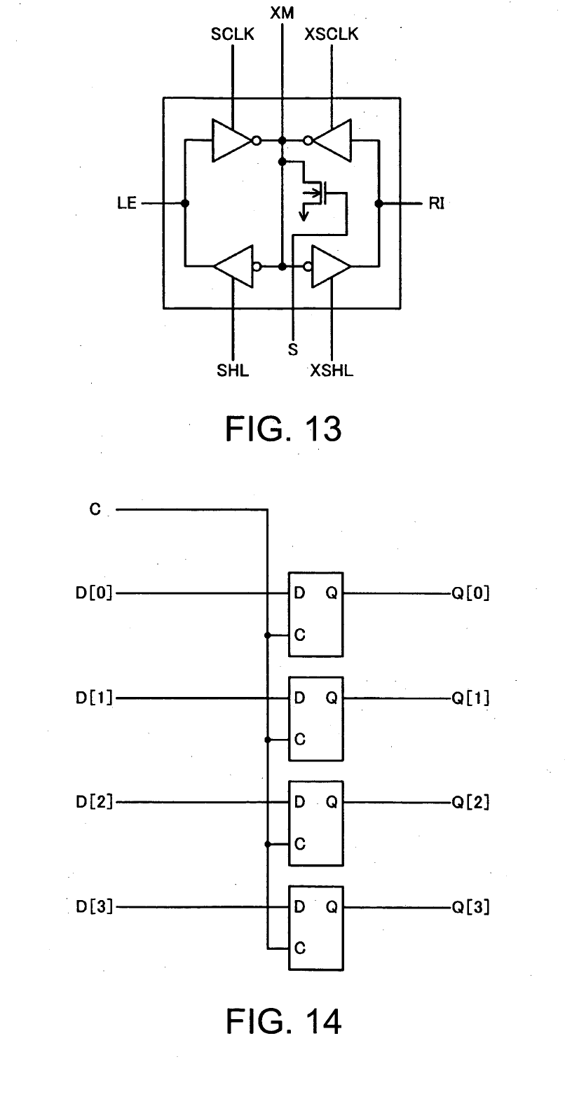

FIG. 13 is a circuit diagram of the latch LLAT0 composing the shift register 710. Here, each of the latches LLAT0 through LLAT3 has the same configuration. As shown in FIG. 13, the latch LLAT0 receives the shift signal RI and outputs the shift signal LE in synchronization with the shift clock SCLK when the shift direction switch signal SHL is “H” level. Meanwhile, the latch LLAT0 receives the shift signal LE and outputs the shift signal RI in synchronization with the shift clock SCLK when the shift direction switch signal SHL is “L” level.

The latch LLAT0 performs shift operations after making the set signal SET become “H” level and a node ND become “L” level.

In FIG. 12, the shift register 710 outputs latch outputs DLATCH_COL0 through DLATCH_COL3 from the latches LLAT0 through LLAT3 or a latch clock DLATCH_LINE in response to the mode switch signal HSC_ENA. More specifically, in the normal mode that is set by the mode switch signal HSC_ENA, the shift register 710 outputs the latch clock DLATCH_LINE as a shift output. Meanwhile, in the horizontal scrolling mode that is set by the mode switch signal HSC_ENA, the shift register 710 outputs the latch outputs DLATCH_COL0 through DLATCH_COL3 as a shift output.

FIG. 14 is a circuit diagram of the data latch 720. The data latch 720 loads a signal selectively output from the selector 700 based on the shift output from the shift register 710.

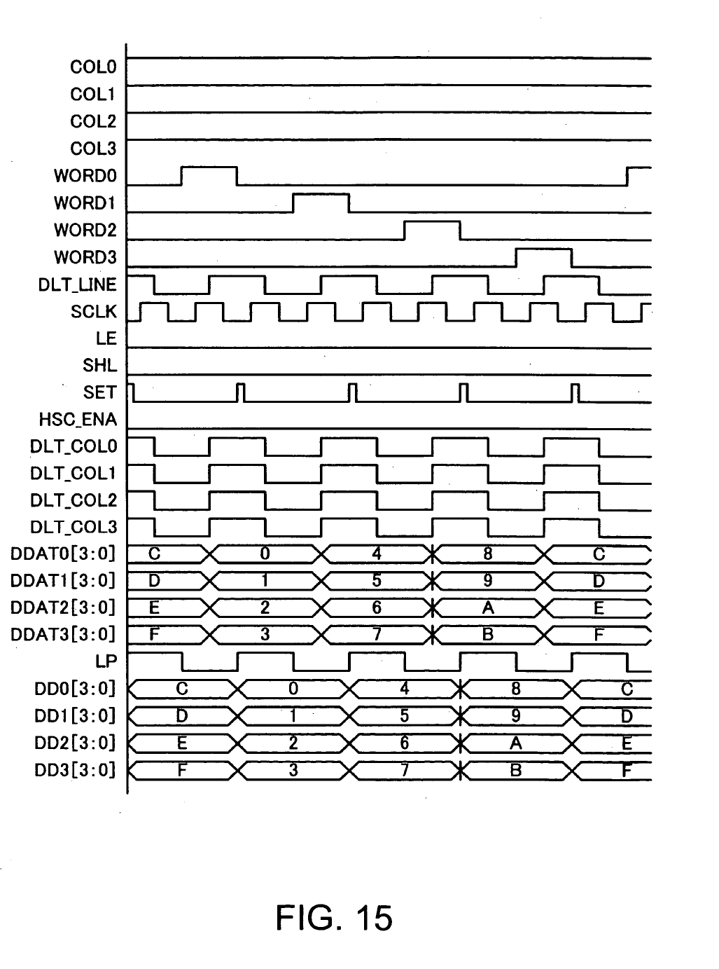

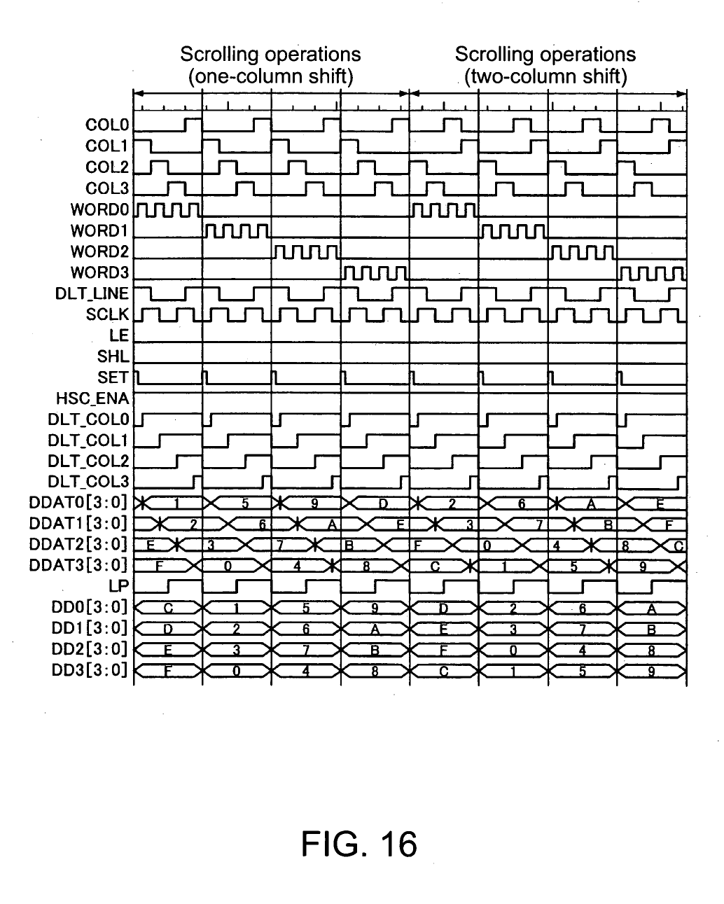

Referring now to FIGS. 15 and 16, operations of the display data RAM 520 and the peripheral circuitry to read out display data shown in FIGS. 8 through 14 will now be described.

FIG. 15 shows an example of operational timing in a normal mode. The normal mode is set by the mode switch signal HSC_ENA.

In the normal mode, a column line selected by the display column address decoder 552 does not change, and is fixed to “H” level. When the display address decoder 556 selects a word line, display data of the display line specified by the word line are output from the display data RAM 520 via the read-out bit lines BITO through BIT3.

The selector 700 selectively outputs the display data from the read-out bit lines BIT0 through BIT3 without any change. The shift register 710 outputs the latch clock DLT_LINE as shift outputs DLT_COL0 through DLT_COL3.

The data latch 720 latches display data read out line by line by means of the shift outputs DLT_COL0 through DLT_COL3. The line latch 730 loads the display data loaded in the data latch 720 based on the latch pulse LP, and outputs the data as latched data DD0 through DD3 to the PWM decoder circuit 590.

FIG. 15 shows display data “p” (“p” is any of 0 through F) retained in a memory cell RAMp.

Accordingly, the configurations shown in FIGS. 8 through 14 read out display data line by line so as to drive data lines of the display panel in the normal mode.

FIG. 16 shows an example of operational timing in a horizontal scrolling mode. FIG. 16 shows operations after scrolling to the right by one column and operations after scrolling to the right by two columns. The horizontal scrolling mode is set by the mode switch signal HSC_ENA.

In the horizontal scrolling mode, a word line is selected by the display address decoder 556 and a column line is selected by the display column address decoder 552. Display data of one pixel stored in a memory cell specified by the word line and the column line are output from the display data RAM 520 via any of the read-out bit lines BIT0 through BIT3.

The selector 700 outputs the display data from the read-out bit lines BIT0 through BIT3 to the scroll bus 708.

In the shift register 710, the shift signal LE is shifted to the right based on the shift clock SCLK after being initialized by the set signal SET. Thus rising edges made by the shift outputs DLT_COL0 through DLT_COL3 are sequentially shifted.

In the data latch 720, display data on the scroll bus 708 are sequentially loaded by the shift outputs DLT_COL0 through DLT_COL3, and output to the line latch 730 as loaded data DDAT0 through DDAT3. The line latch 730 loads the display data loaded in the data latch 720 based on the latch pulse LP, and outputs the data as latched data DD0 through DD3 to the PWM decoder circuit 590.

As shown in FIG. 16, in order to horizontally scroll the X driver IC 400, it is sufficient to change the column-line selection timing of the display column address decoder 552 without changing operations of the shift register 710. This means that it is sufficient to change the timing of supplying a display column address to the display column address decoder 552. This makes it possible to load display data shifted in line with the amount of scrolling in the line latch 730.

Accordingly, the configurations shown in FIGS. 8 through 14 drive data lines of the display panel based on the display data shifted in line with the amount of scrolling in the horizontal scrolling mode.

It should be noted that the invention is not limited to the above-mentioned embodiment, and can be modified within the scope of the invention.

While an active-matrix display panel is used in the above-mentioned embodiment, a passive-matrix display panel is also used for implementing the invention. Also, while display data are driven line by line in the above-mentioned embodiment, it is also possible to read out display data by multiple data lines. Furthermore, while display data are read out pixel by pixel to generate display data for horizontal scrolling in the above-mentioned embodiment, it is also possible to read out display data by multiple pixels for generating display data for horizontal scrolling.

As for the dependent claims of the invention, it is possible to omit part of the elements claimed in the claims on which they depend. Moreover, the feature claimed in one of the independent claims of the invention may be dependent on another independent claim.

What is claimed is:

1. A display driver for driving data lines of an electro optic device based on display data, comprising:
a display data random access memory including a plurality of word lines, a plurality of column lines, and a plurality of memory cells each storing display data of one pixel;
a display address decoder selecting a word line of the display data random access memory based on a display address;
a display column address decoder selecting a column line of the display data random access memory based on a display column address;
a plurality of read-out bit lines each commonly coupled to a memory cell group specified by a corresponding column line;
a scroll bus coupled to the plurality of read-out bit lines;
a plurality of data latches each corresponding to each data line of the electro optic device and loading display data on the scroll bus;
and a driving circuit driving the data lines based on the display data loaded in the plurality of data latches;
wherein display data of one pixel are read out from a memory cell specified by a word line selected by the display address decoder and a column line selected by the display column address decoder, the data are output to the scroll bus via the read-out bit line coupled to the memory cell, and the data on the scroll bus are loaded in each of the plurality of data latches.

2. The display driver according to claim 1, further comprising:
a shift register outputting a shift output shifted based on a given shift clock;
wherein each of the plurality of data latches loads display data on the scroll bus based on a shift output of each stage of the shift register.

3. The display driver according to claim 1, further comprising:
a line latch loading display data that are loaded in the plurality of data latches in one horizontal scan cycle;
wherein the driving circuit drives the data lines based on display data loaded in the line latches instead of the plurality of data latches.

4. A display driver for driving data lines of an electro optic device based on display data, comprising:
a display data random access memory including a plurality of word lines, a plurality of column lines, and a plurality of memory cells each storing display data of one pixel;
a display address decoder selecting a word line of the display data random access memory based on a display address;
a display column address decoder selecting a column line of the display data random access memory based on a display column address;
a plurality of read-out bit lines each commonly coupled to a memory cell specified by a column line;
a scroll display data generating circuit including a plurality of data latches that each correspond to each data line of the electro optic device, shifting display data of one pixel that are output to each read-out bit line by a shift amount in line with a given scroll amount, and loading the data in any of the plurality of data latches, so as to generate display data of one horizontal scan line;
and a driving circuit driving the data lines based on the display data of one horizontal scan line generated by the scroll display data generating circuit.

5. An electro optic device, comprising:
a plurality of scan lines;
a plurality of data lines;
a plurality of pixels coupled to the plurality of scan lines and the plurality of data lines;
a scan driver scanning the plurality of scan lines;
and the display driver according to claim 1 driving the plurality of data lines.

6. An electro optic device, comprising:
a display panel including a plurality of scan lines, a plurality of data lines, and a plurality of pixels coupled to the plurality of scan lines and the plurality of data lines;
a scan driver scanning the plurality of scan lines;
and the display driver according to claim 1 driving the plurality of data lines.

7. An electronic apparatus, comprising:
the electro optic device according to claim 5;
and a display data generator generating display data to be supplied to the electro optic device.

8. A display driving method for driving data lines of an electro optic device based on display data that are read out from a display data random access memory including a plurality of word lines, a plurality of column lines, and a plurality of memory cells each storing display data of one pixel, comprising:
specifying a memory cell by a word line out of the plurality of word lines and a column line out of the plurality of column lines;
outputting display data of one pixel that are stored in the memory cell to a scroll bus via a read-out bit line commonly coupled to a memory cell group that is specified by the column line;
loading the display data of one pixel on the scroll bus in any of a plurality of data latches each corresponding to each data line of the electro optic device;
and driving the data lines of the electro optic device based on the display data loaded in the plurality of data latches.

9. The display driving method according to claim 8,
wherein the step of loading the display data of one pixel on the scroll bus in each of the plurality of data latches is repeated for the number of pixels to be driven in one horizontal scan cycle so as to load display data of one horizontal scan line in the plurality of data latches, and the data lines of the electro optic device are driven based on the display data loaded in the plurality of data latches.
